(19) United States
(12) Patent Application Publication
(10) Pub. No.: US 2016/0178979 A1
(43) Pub. Date: Jun. 23, 2016

(54) LIQUID CRYSTAL DISPLAY DEVICE

(71) Applicant: SHARP KABUSHIKI KAISHA, Osaka-shi, Osaka (JP)

(72) Inventors: Yuichi KITA, Osaka-shi (JP); Yoshiki NAKATANI, Osaka-shi (JP); Takao IMAOKU, Osaka-shi (JP); Iori AOYAMA, Osaka-shi (JP); Takatomo YOSHIOKA, Osaka-shi (JP)

(73) Assignee: SHARP KABUSHIKI KAISHA, Osaka-shi, Osaka (JP)

(21) Appl. No.: 14/772,793

(22) PCT Filed: Feb. 21, 2014
(86) PCT No.: PCT/JP2014/054148

§ 371 Date: Sep. 4, 2015

(30) Foreign Application Priority Data
Mar. 7, 2013 (JP) 2013-045835

(51) Int. Cl. G02F 1/1343; G02F 1/1333; G02F 1/1335; G02F 1/139; G02F 1/1337

(52) U.S. Cl. CPC G02F 1/134363; G02F 1/134336; G02F 1/1396; G02F 1/1337; G02F 1/133528; G02F 1/133345; G02F 1/133621; G02F 2001/134381; G02F 2001/133738; G02F 2001/133746; G02F 2001/133531; G02F 2001/13706

(57) ABSTRACT

A liquid crystal display device (100) has a liquid crystal display panel (1), which includes a first substrate (10), a second substrate (20), and a liquid crystal layer (30). The first substrate includes a first electrode (11) provided for each pixel, and a second electrode (12) for generating a lateral field across the liquid crystal layer in cooperation with the first electrode, whereas the second substrate includes a third electrode (21) for generating a vertical field across the liquid crystal layer in cooperation with the first electrode and the second electrode. Each pixel is capable of switchably presenting a black displaying state where black displaying is performed with a vertical field being generated across the liquid crystal layer, a white displaying state where white displaying is performed with a lateral field being generated across the liquid crystal layer, or a transparent displaying state where a rear face side of the liquid crystal display panel is visible in a see-through manner with no voltage being applied to the liquid crystal layer.

### TECHNICAL FIELD

The present invention relates to a liquid crystal display device, and more particularly to a liquid crystal display device which is suitable for use as a see-through display.

### BACKGROUND ART

In recent years, see-through displays have been attracting attention as the display devices for information display systems or digital signage. In a see-through display, the background (i.e., the rear-face side of the display panel) is visible in a see-through manner, whereby information to be indicated on the display panel is displayed as if overlaid on the background. Thus, a see-through display has good appeal and eyecatchingness. Application of see-through displays to showcases and show windows has also been proposed.

In the case where a liquid crystal display device is used for a see-through display, its low efficiency of light utilization will be a detriment. The reasons for the low efficiency of light utilization of a liquid crystal display device are the color filters and polarizing plates, which are provided in generic liquid crystal display devices. The color filters and polarizing plates absorb light in specific wavelength regions or light of specific polarization directions.

This has led to the idea of using a liquid crystal display device of the field sequential method. Under the field sequential method, multicolor displaying is performed through time-division switching between colors of light with which a liquid crystal display panel is irradiated from an illumination element. This eliminates the need for color filters, thus improving the efficiency of light utilization. However, in the field sequential method, the liquid crystal display device needs to have a rapid response.

Patent Documents 1 and 2 disclose liquid crystal display devices having improved response characteristics because of an electrode structure being provided which is capable of switchably generating a vertical field and a lateral field across the liquid crystal layer. In the liquid crystal display devices disclosed in Patent Documents 1 and 2, a vertical field is generated across the liquid crystal layer in either one of the transition (rise) from a black displaying state to a white displaying state and the transition (fall) from a white displaying state to a black displaying state, while a lateral field (fringing field) is generated across the liquid crystal layer in the other. Therefore, the torque due to voltage application acts on the liquid crystal molecules in both of a rise and a fall, whereby good response characteristics are attained.

Patent Document 3 also proposes a liquid crystal display device which realizes a rapid response by allowing the alignment regulating force of an electric field to act on the liquid crystal molecules in both a rise and a fall.

### CITATION LIST

### Patent Literature

[Patent Document 1] Japanese National Phase PCT Laid-Open Publication No. 2006-523850

[Patent Document 2] Japanese Laid-Open Patent Publication No. 2002-365657

[Patent Document 3] International Publication No. 2013/001979

### SUMMARY OF INVENTION

### Technical Problem

However, it has been found that when such liquid crystal display devices as are disclosed in Patent Documents 1, 2 and 3 are used for a see-through display, the problem of background blur (it being perceived as double images) occurs for reasons that are described in detail later, thus deteriorating the display quality. Note that Patent Documents 1, 2 and 3 themselves fail to mention any such use (i.e., application to a see-through display); the aforementioned problem is a new finding by the inventors.

The present invention has been made in view of the above problems, and an objective thereof is to provide a liquid crystal display device which excels in both response characteristics and display quality, the liquid crystal display device being suitable for use as a see-through display.

### Solution to Problem

A liquid crystal display device according to an embodiment of the present invention is a liquid crystal display device comprising a liquid crystal display panel including a first substrate and a second substrate opposing each other and a liquid crystal layer provided between the first substrate and the second substrate, the liquid crystal display device having a plurality of pixels arranged in a matrix array, wherein, the first substrate includes a first electrode provided for each of the plurality of pixels, and a second electrode for generating a lateral field across the liquid crystal layer in cooperation with the first electrode; the second substrate includes a third electrode opposing the first electrode and the second electrode for generating a vertical field across the liquid crystal layer in cooperation with the first electrode and the second electrode; and each of the plurality of pixels is capable of switchably presenting a black displaying state where black displaying is performed with a vertical field being generated across the liquid crystal layer, a white displaying state where white displaying is performed with a lateral field being generated across the liquid crystal layer, or a transparent displaying state where a rear face side of the liquid crystal display panel is visible in a see-through manner with no voltage being applied to the liquid crystal layer.

In one embodiment, in the transparent displaying state, liquid crystal molecules in the liquid crystal layer take a homogeneous alignment.

In one embodiment, the first electrode has a plurality of slits extending along a predetermined direction; and in the white displaying state and the transparent displaying state, the liquid crystal molecules in the liquid crystal layer are aligned substantially orthogonal to the predetermined direction.

In one embodiment, the liquid crystal display panel further includes a pair of horizontal alignment films opposing each other via the liquid crystal layer; and a pretilt direction defined by each of the pair of horizontal alignment films is substantially orthogonal to the predetermined direction.

In one embodiment, the liquid crystal display panel further includes a pair of polarizing plates opposing each other via the liquid crystal layer, the pair of polarizing plates being placed in crossed Nicols; and respective transmission axes of the pair of polarizing plates constitute angles of substantially 45° with respect to the respective pretilt directions defined by the pair of horizontal alignment films.

In one embodiment, in the transparent displaying state, liquid crystal molecules in the liquid crystal layer take a twist alignment.

In one embodiment, the first electrode has a plurality of slits extending along a predetermined direction; and in the white displaying state and the transparent displaying state, the liquid crystal molecules near a center along a thickness direction of the liquid crystal layer are aligned substantially parallel to the predetermined direction.

In one embodiment, the liquid crystal display panel further includes a pair of horizontal alignment films opposing each other via the liquid crystal layer; and a pretilt direction defined by each of the pair of horizontal alignment films constitutes an angle of substantially 45° with respect to the predetermined direction.

In one embodiment, the liquid crystal display panel further includes a pair of polarizing plates opposing each other via the liquid crystal layer, the pair of polarizing plates being placed in crossed Nicols; and respective transmission axes of the pair of polarizing plates are substantially parallel or substantially orthogonal to the respective pretilt directions defined by the pair of horizontal alignment films.

In one embodiment, the first electrode is provided via an insulating layer on the second electrode.

In one embodiment, the first substrate further includes a fourth electrode for generating a vertical field across the liquid crystal layer in cooperation with the first electrode, the second electrode, and the third electrode; and the first electrode and the second electrode are provided via an insulating layer on the fourth electrode.

In one embodiment, the liquid crystal layer contains liquid crystal molecules having positive dielectric anisotropy.

One embodiment further comprises an illumination element capable of switchably irradiating the liquid crystal display panel with a plurality of color rays including red light, green light, and blue light.

In one embodiment, the above liquid crystal display device performs multicolor displaying by a field sequential method.

In one embodiment, the liquid crystal display panel includes no color filters.

### Advantageous Effects of Invention

According to an embodiment of the present invention, there is provided a liquid crystal display device which excels in both response characteristics and display quality, the liquid crystal display device being suitable for use as a see-through display.

### BRIEF DESCRIPTION OF DRAWINGS

FIG. 1 A cross-sectional view schematically showing a liquid crystal display device 100 according to an embodiment of the present invention.

FIG. 2 A plan view schematically showing a liquid crystal display device 100 according to an embodiment of the present invention.

FIG. 3 A plan view showing a specific wiring structure for a rear substrate 10 of the liquid crystal display device 100.

FIGS. 4 (a) and (b) are a cross-sectional view and a plan view showing an alignment of liquid crystal molecules 31 in a black displaying state of the liquid crystal display device 100.

FIGS. 5 (a) and (b) are a cross-sectional view and a plan view showing an alignment of liquid crystal molecules 31 in a white displaying state of the liquid crystal display device 100.

FIGS. 6 (a) and (b) are a cross-sectional view and a plan view showing an alignment of liquid crystal molecules 31 in a transparent displaying state of the liquid crystal display device 100.

FIG. 7 A cross-sectional view schematically showing a liquid crystal display device 200 according to an embodiment of the present invention.

FIG. 8 A plan view schematically showing a liquid crystal display device 200 according to an embodiment of the present invention.

FIGS. 9 (a) and (b) are a cross-sectional view and a plan view showing an alignment of liquid crystal molecules 31 in a black displaying state of the liquid crystal display device 200.

FIGS. 10 (a) and (b) are a cross-sectional view and a plan view showing an alignment of liquid crystal molecules 31 in a white displaying state of the liquid crystal display device 200.

FIGS. 11 (a) and (b) are a cross-sectional view and a plan view showing an alignment of liquid crystal molecules 31 in a transparent displaying state of the liquid crystal display device 200.

FIG. 12 A graph showing a relationship between time T(ms) and normalized luminance in a rise period and a fall period, as obtained through a simulation.

FIG. 13 A diagram showing equipotential lines and orientation directions of liquid crystal molecules 31 at 39 ms after start of a rise period (T=49 ms), as obtained through a simulation.

FIG. 14 A graph showing relationships between time T(ms) and normalized luminance in a rise period and a fall period in two types of construction, as obtained through a simulation.

FIGS. 15 (a) and (b) are a perspective view and a cross-sectional view schematically showing another construction for the liquid crystal display device 100.

FIG. 16 A cross-sectional view schematically showing another construction for the liquid crystal display device 100.

FIG. 17 A cross-sectional view schematically showing another construction for the liquid crystal display device 100.

FIG. 18 A cross-sectional view schematically showing a liquid crystal display device 800 of Comparative Example, where (a) shows a state of black displaying and (b) shows a state of white displaying.

FIG. 19 A diagram schematically showing a doubling blur.

### DESCRIPTION OF EMBODIMENTS

Hereinafter, embodiments of the present invention will be described with reference to the drawings. Note that the present invention is not limited to the following embodiments.

### Embodiment 1

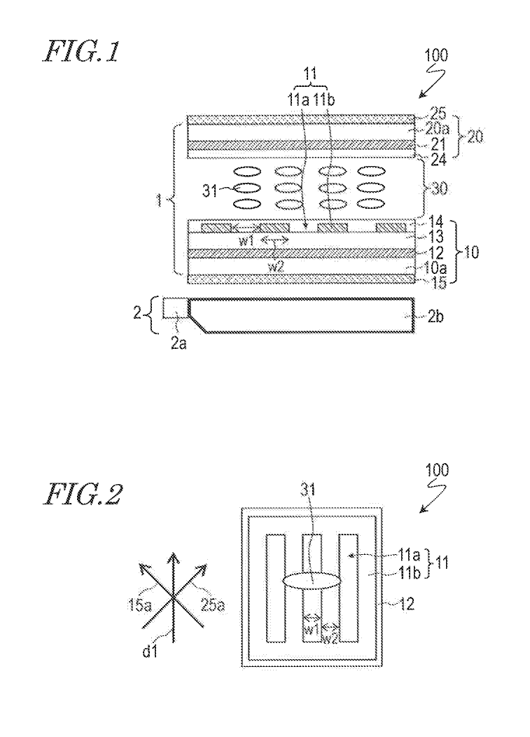

FIG. 1 and FIG. 2 show a liquid crystal display device 100 according to the present embodiment. FIG. 1 is a cross-sectional view schematically showing the liquid crystal display device 100, and FIG. 2 is a plan view schematically showing the liquid crystal display device 100.

As shown in FIG. 1, the liquid crystal display device 100 includes a liquid crystal display panel 1 and an illumination element 2. Moreover, the liquid crystal display device 100 includes a plurality of pixels arranged in a matrix array. FIG. 1 and FIG. 2 show an electrode structure corresponding to one pixel. As will be described later, the liquid crystal display device 100 performs multicolor displaying by the field sequential method.

The liquid crystal display panel 1 includes a first substrate 10 and a second substrate 20 opposing each other, and a liquid crystal layer 30 interposed between the first substrate 10 and the second substrate 20. Hereinafter, between the first substrate 10 and the second substrate 20, the first substrate 10 being positioned relatively on the rear face side will be referred to as the “rear substrate”, and the second substrate 20 being positioned relatively on the front face side (the viewer's side) will be referred to as the “front substrate”.

The rear substrate 10 includes a first electrode 11 provided for each of the plurality of pixels and a second electrode 12 which cooperates with the first electrode 11 to generate a lateral field across the liquid crystal layer 30. Via an insulating layer 13, the first electrode 11 is located on the second electrode 12. Stated otherwise, the second electrode 12 is located under the first electrode 11 via the insulating layer 13. Hereinafter, between the first electrode 11 and the second electrode 12, the first electrode 11 taking a relatively upper position will be referred to as the “upper electrode”, and the second electrode 12 taking a relatively lower position will be referred to as the “lower electrode”. The lower electrode 12, insulating layer 13, and the upper electrode 11 are supported by an insulative transparent substrate (e.g., a glass substrate) 10a.

As shown in FIG. 1 and FIG. 2, the upper electrode includes a plurality of slit 11a extending along a predetermined direction d1, and a plurality of branches 11b extending in parallel to the direction d1 that the slits 11a extend. Note that the number of slits 11a and the number of branches 11b are not limited to those exemplified in FIG. 1 and FIG. 2. There is no particular limitation as to the width w1 of the slits 11a. The width w1 of the slits 11a is typically not less than 2 μm and not more than 10 μm. There is no particular limitation as to the width w2 of the branches 11b, either. The width w2 of the branches 11b is typically not less than 2 μm and not more than 10 μm. The upper electrode 11 is made of a transparent electrically conductive material (e.g., ITO).

The lower electrode 12 has no slits. That is, the lower electrode 12 is a so-called spread electrode. The lower electrode 12 is also made of a transparent electrically conductive material (e.g., ITO).

There is no particular limitation as to the material of the insulating layer 13. As the material of the insulating layer 13, for example, an inorganic material such as silicon oxide (SiO₂) or silicon nitride (SiN), or an organic material such as a photo-sensitive resin can be used.

The front substrate 20 includes a third electrode (hereinafter referred to as the “counter electrode”) 21 which opposes the upper electrode (first electrode) 11 and the lower electrode (second electrode) 12. The counter electrode 21 is supported by an insulative transparent substrate (e.g., a glass substrate) 20a.

The counter electrode 21 generates a vertical field across the liquid crystal layer 30 in cooperation with the upper electrode 11 and the lower electrode 12. The counter electrode 21 is made of a transparent electrically conductive material (e.g., ITO).

The liquid crystal layer 30 contains liquid crystal molecules 31 having positive dielectric anisotropy. Note that the orientation directions of the liquid crystal molecules 31 shown in FIG. 1 and FIG. 2 are those in a state where no voltage is applied to the liquid crystal layer 30.

The liquid crystal display panel 1 further includes a pair of horizontal alignment films 14 and 24 which oppose each other via the liquid crystal layer 30. One (which hereinafter may be referred to as the “first horizontal alignment film”) 14 of the pair of horizontal alignment films 14 and 24 is formed on a surface of the rear substrate 10 that faces the liquid crystal layer 30. The other (which hereinafter may be referred to as the “second horizontal alignment film”) 24 of the pair of horizontal alignment films 14 and 24 is formed on a surface of the front substrate 20 that faces the liquid crystal layer 30.

The first horizontal alignment film 14 and the second horizontal alignment film 24 have each been subjected to an alignment treatment, thus possessing an alignment regulating force that causes the liquid crystal molecules 31 in the liquid crystal layer 30 to be aligned in a predetermined direction (called a “pretilt direction”). As the alignment treatment, for example, a rubbing treatment or a photo-alignment treatment is conducted.

The pretilt direction defined by each of the first horizontal alignment film 14 and the second horizontal alignment film 24 is set so that the liquid crystal molecules 31 will take a homogeneous alignment in a state where no voltage is applied to the liquid crystal layer 30 (i.e., a state where no electric field is generated). Specifically, the pretilt direction defined by each of the first horizontal alignment film 14 and the second horizontal alignment film 24 is substantially orthogonal to the direction d1 that the slits 11a in the upper electrode 11 extend. In other words, the pretilt direction defined by the first horizontal alignment film 14 and the pretilt direction defined by the second horizontal alignment film 24 are parallel or antiparallel to each other.

Moreover, the liquid crystal display panel 1 further includes a pair of polarizing plates 15 and 25 which oppose each other via the liquid crystal layer 30. A transmission axis (polarization axis) 15a of one (which hereinafter may be referred to as the “first polarizing plate”) 15 of the pair of polarizing plates 15 and 25 is substantially orthogonal to a transmission axis (polarization axis) 25a of the other (which hereinafter may be referred to as the “second polarizing plate”) 25, as shown in FIG. 2. In other words, the first polarizing plate 15 and the second polarizing plate 25 are placed in crossed Nicols. In the present embodiment, the respective transmission axes 15a and 25a of the first polarizing plate 15 and the second polarizing plate 25 constitute angles of substantially 45° with respect to the pretilt directions which are respectively defined by the first horizontal alignment film 14 and the second horizontal alignment film 24. Therefore, the respective transmission axes 15a and 25a of the first polarizing plate 15 and the second polarizing plate 25 constitute angles of substantially 45° with respect to the direction d1 that the slits 11a in the upper electrode 11 extend.

The illumination element (referred to as the “backlight”) 2 is located on the rear face side of the liquid crystal display panel 1. The illumination element 2 is able to switchably irradiate the liquid crystal display panel 1 with a plurality of color rays including red light, green light, and blue light.

As the illumination element 2, for example, an edgelight-type backlight such as that shown in FIG. 1 can be used. The edgelight-type backlight 2 includes a light source unit 2a and a light guide plate 2b. The light source unit 2a is capable of emitting a plurality of color rays including red light, green light, and blue light. For example, the light source unit 2a includes a red LED, a green LED, and a blue LED. The light guide plate 2b guides color rays which are emitted from the light source unit 2a to the liquid crystal display panel 1.

The liquid crystal display device 100 performs multicolor displaying by the field sequential method. Therefore, the liquid crystal display panel 1 lacks color filters.

When a predetermined voltage is applied between the upper electrode 11 and the lower electrode 12 (i.e., a predetermined potential difference is introduced therebetween), a lateral field (fringing field) is generated across the liquid crystal layer 30. A “lateral field” is an electric field containing a component which is substantially parallel to the substrate plane. The direction of the lateral field which is generated by the upper electrode 11 and the lower electrode 12 is substantially orthogonal to the direction d1 that the slits 11a in the upper electrode 11 extend.

When a predetermined voltage is applied between the counter electrode 21 and the upper electrode 11 and lower electrode 12 (i.e., a predetermined potential difference is introduced therebetween), a vertical field is generated. A “vertical field” is an electric field whose direction is substantially parallel to the substrate-plane normal direction.

The liquid crystal display device 100 is constructed so that the intensities of the lateral field and the vertical field can be controlled with respect to each pixel. Typically, the liquid crystal display device 100 is constructed so that a voltage differing from pixel to pixel can be respectively supplied for the upper electrode 11 and the lower electrode 12. Specifically, both the upper electrode 11 and the lower electrode 12 are formed in isolated pieces corresponding to pixels, such that each pixel has a switching element (e.g., a thin film transistor; not shown) electrically connected to the upper electrode 11 and a switching element (e.g., a thin film transistor; not shown) electrically connected to the lower electrode 12. A predetermined voltage is supplied to each of the upper electrode 11 and the lower electrode 12 via a corresponding switching element. Moreover, the counter electrode 21 is formed as a single electrically conductive film that is continuous across all pixels. Therefore, a common potential is applied to the counter electrode 21 for all pixels.

FIG. 3 shows an exemplary of a specific wiring structure for the rear substrate 10. In the construction shown in FIG. 3, a first TFT 16A corresponding to the upper electrode 11 and a second TFT 16B corresponding to the lower electrode 12 are provided for each pixel. The respective gate electrodes 16g of the first TFT 16A and the second TFT 16B are electrically connected to a gate bus line (scanning line) 17. Herein, the portions of the gate bus line 17 that overlap the channel regions of the first TFT 16A and the second TFT 16B function as the gate electrodes 16g. Respective source electrodes 16s of the first TFT 16A and the second TFT 16B are electrically connected to source bus lines (signal lines) 18. Herein, portions branching out from the source bus lines 18 function as the source electrodes 16s. A drain electrode 16d of the first TFT 16A is electrically connected to the upper electrode 11. On the other hand, a drain electrode 16d of the second TFT 16B is electrically connected to the lower electrode 12. Note that the wiring structure of the rear substrate 10 is not limited to what is exemplified in FIG. 3.

In the liquid crystal display device 100 of the present embodiment, each of the plurality of pixels is able to switchably present: a “black displaying state”, where black displaying is performed with a vertical field being generated across the liquid crystal layer 30; a “white displaying state”, where white displaying is performed with a lateral field being generated across the liquid crystal layer 30; or a “transparent displaying state”, where the rear face side (i.e., the background) of the liquid crystal display panel 1 is visible in a see-through manner with no voltage being applied to the liquid crystal layer 30.

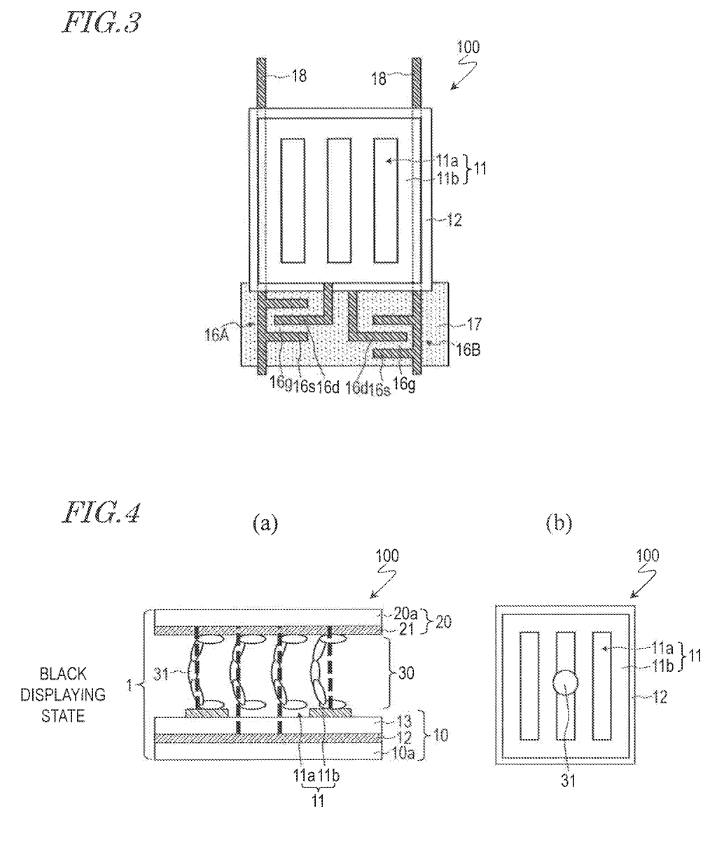

Hereinafter, with reference to FIG. 4, FIG. 5, and FIG. 6, the black displaying state, the white displaying state, and the transparent displaying state will be described in more detail.

FIGS. 4(a) and (b) show an alignment of liquid crystal molecules 31 in a black displaying state. In the black displaying state, a predetermined voltage is applied between the counter electrode 21 and the upper electrode 11 and lower electrode 12 (e.g., a potential of 0 V being given to the counter electrode 21 and a potential of 7.5 V being given to the upper electrode 11 and lower electrode 12), whereby a vertical field is generated across the liquid crystal layer 30. FIG. 4(a) schematically shows the electric lines of force in this state with broken lines.

In this black displaying state, as shown in FIGS. 4(a) and (b), the liquid crystal molecules 31 in the liquid crystal layer 30 are aligned substantially vertically to the substrate plane (the surfaces of the rear substrate 10 and the front substrate 20)(i.e., substantially parallel to the layer normal direction of the liquid crystal layer 30). Note that the liquid crystal molecules (which may also be referred to as “interfacial liquid crystal”) 31 in the close neighborhood of the first horizontal alignment film 14 and the second horizontal alignment film 24 are strongly affected by the alignment regulating forces of the first horizontal alignment film 14 and the second horizontal alignment film 24, and therefore remain aligned substantially parallel to the substrate plane. However, since the liquid crystal molecules (which may also be referred to as “bulk liquid crystal”) 31 in the other regions (i.e., a greater region of the liquid crystal layer 30) are aligned substantially vertically to the substrate plane, black displaying can be attained without problems.

FIGS. 5(a) and (b) show an alignment of liquid crystal molecules 31 in a white displaying state. In the white displaying state, a predetermined voltage is applied between the upper electrode 11 and the lower electrode 12 (e.g., a potential of 0 V being given to the upper electrode 11 and the counter electrode 21, and a potential of 7.5 V being given to the lower electrode 12), whereby a lateral field (fringing field) is generated across the liquid crystal layer 30. FIG. 5(a) schematically shows the electric lines of force in this state with broken lines.

In this white displaying state, as shown in FIGS. 5(a) and (b), the liquid crystal molecules 31 in the liquid crystal layer 30 are aligned substantially in parallel to the substrate plane (i.e., substantially vertically to the layer normal direction of the liquid crystal layer 30). More specifically, the liquid crystal molecules 31 are aligned so as to be substantially orthogonal to the direction d1 that the slits 11a in the upper electrode 11 extend. In other words, the liquid crystal molecules 31 are aligned so as to constitute an angle of substantially 45° with respect to the respective transmission axes 15a and 25a of the first polarizing plate 15 and the second polarizing plate 25.

FIGS. 6(a) and (b) shows an alignment of liquid crystal molecules 31 in a transparent displaying state. In the transparent displaying state, no voltage is applied to the liquid crystal layer 30 (e.g., a potential of 0 V is given to all of the upper electrode 11, the lower electrode 12, and the counter electrode 21), so that neither a vertical field nor a lateral field is generated across the liquid crystal layer 30.

In this transparent displaying state, as shown in FIGS. 6(a) and (b), the liquid crystal molecules 31 in the liquid crystal layer 30 take a homogeneous alignment. In other words, the liquid crystal molecules 31 are aligned substantially in parallel to the substrate plane (i.e., substantially vertically to the layer normal direction of the liquid crystal layer 30). More specifically, liquid crystal molecules 31 are aligned so as to be substantially orthogonal to the direction d1 that the slits 11a in the upper electrode 11 extend. In other words, the liquid crystal molecules 31 are aligned so as to constitute an angle of substantially 45° with respect to the respective transmission axes 15a and 25a of the first polarizing plate 15 and the second polarizing plate 25. The light transmittance of each pixel of the liquid crystal display device 100 is the highest in this transparent displaying state (i.e., higher than those in the black displaying state and the white displaying state).

As described above, the liquid crystal display device 100 of the present embodiment performs multicolor displaying by the field sequential method, so that the liquid crystal display panel 1 does not need color filters. Therefore, the efficiency of light utilization is improved. Moreover, in the liquid crystal display device 100, a vertical field is generated across the liquid crystal layer in the black displaying state and a lateral field is generated across the liquid crystal layer 30 in the white displaying state; therefore, torque due to voltage application can act on the liquid crystal molecules 31 in both a fall (i.e., a transition from the white displaying state to the black displaying state) and a rise (i.e., a transition from the black displaying state to the white displaying state). As a result, good response characteristics are attained.

Furthermore, in the liquid crystal display device 100 of the present embodiment, each pixel is capable of presenting not only the black displaying state and the white displaying state, but also a transparent displaying state, which is a state where no voltage is applied to the liquid crystal layer 30. By displaying the background in this transparent displaying state, it becomes possible to prevent the problem of background blur (it being perceived as double images). Hereinafter, the reasons why this problem (doubling blur) occurs in the liquid crystal display devices of Patent Documents 1 to 3 will be described with reference to a liquid crystal display device according to Comparative Example.

FIGS. 18(a) and (b) show a state of black displaying and a state of white displaying conducted by the liquid crystal display device 800 of Comparative Example, respectively. The liquid crystal display device 800 of Comparative Example has the same construction as that of the liquid crystal display device shown in FIG. 1 and FIG. 2 of Patent Document 3.

The liquid crystal display device 800 includes an array substrate 810 and a counter substrate 820, and a liquid crystal layer 830 provided therebetween. The array substrate 810 includes: a glass substrate 810a; and a lower electrode 812, an insulating layer 813, and a pair of interdigitated electrodes (upper electrode) 817 and 818, these being stacked in this order on the glass substrate 810a. On the other hand, the counter substrate 820 includes a substrate 820a and a counter electrode 821 formed on the glass substrate 820a.

The liquid crystal layer 830 contains liquid crystal molecules 831 having positive dielectric anisotropy. In the liquid crystal display device 800, the liquid crystal molecules 831 in the liquid crystal layer 830 take a vertical alignment in the absence of an applied voltage.

In the liquid crystal display device 800 of Comparative Example, when conducting black displaying, a predetermined voltage is applied between the counter electrode 821, the lower electrode 812, and the upper electrode (a pair of interdigitated electrodes) 817, 818 (e.g., a potential of 7V being given to the counter electrode 821, and a potential of 14 V being given to the lower electrode 812 and the upper electrode 817, 818), thereby generating a vertical field across the liquid crystal layer 830. As a result, the liquid crystal molecules 831 are aligned substantially vertically to the substrate plane as shown in FIG. 18(a).

Moreover, in the liquid crystal display device 800 of Comparative Example, when conducting white displaying, a predetermined voltage is applied between the pair of interdigitated electrodes 817 and 818 (e.g., a potential of 0 V being given to one interdigitated electrode 817 and a potential of 14 V given to the other interdigitated electrode 818), thereby generating a lateral field across the liquid crystal layer 830. As a result, as shown in FIG. 18(b), the liquid crystal molecules 831 take an inclined alignment with respect to the substrate-plane normal direction.

In the case where the liquid crystal display device 800 of Comparative Example is simply used for a see-through display, if see-through displaying were to be conducted, i.e., when conducting displaying such that the background is visible in a see-through manner, the white displaying state will be utilized, which is a state under high pixel light transmittance. However, the state for conducting white displaying is a state in which the liquid crystal molecules 830 are aligned by applying a voltage across the liquid crystal layer 830, so that a refractive index distribution occurs within the pixel. Therefore, light L from the rear face side is scattered due to this refractive index distribution (i.e., the direction of travel of the light L changes; see FIG. 18(b)), thus blurring the background. Consequently, as shown in FIG. 19, a viewer V observing the background BG via the see-through display STDP will perceive the background BG as double images.

Thus, doubling blur will occur when see-through displaying is conducted in the white displaying state, which is a state where voltage is applied across the liquid crystal layer 30. On the other hand, in the liquid crystal display device 100 of the present embodiment, the background (see-through displaying) is displayed in pixels which are in a state where no voltage is applied to the liquid crystal layer (transparent displaying state), whereby doubling blur is prevented, and the quality of see-through displaying can be improved.

Note that, if the white displaying state of the liquid crystal display device 100 is used for see-through displaying, doubling blur will similarly occur. The reason is that, in the white displaying state, a refractive index distribution occurs within the pixel under the influence of the electric field being generated in the liquid crystal layer 30. While FIG. 5(a) shows an ideal alignment, in actuality, the liquid crystal molecules 31 in the white displaying state will not take a uniform homogeneous alignment, unlike in the transparent displaying state; therefore, a lower transmittance than that in the transparent displaying state will result. Moreover, in the liquid crystal display device 800 of Comparative Example, see-through displaying cannot be attained in a state where no voltage is applied to the liquid crystal layer 830, because of low light transmittance (essentially the same transmittance as in a state of black displaying).

As described above, the liquid crystal display device 100 of the present embodiment excels in both response characteristics and display quality, and thus is suitably used as a see-through display.

Note that each of the plurality of pixels of the liquid crystal display device 100 is able to present an “intermediate level displaying state” of presenting a luminance corresponding to an intermediate gray scale level, in addition to the black displaying state of presenting a luminance corresponding to the lowest gray scale level, the white displaying state of presenting a luminance corresponding to the highest gray scale level, and the transparent displaying state of conducting see-through displaying. In an intermediate level displaying state, desired transmittance can be realized by adjusting the intensity of the lateral field (fringing field) to be generated across the liquid crystal layer 30 (e.g., a potential of 0 V being given to the counter electrode 21 and that of 7.5 V being given to the lower electrode 12, and a potential which is greater than 0 V and less than 7.5 V being given to the upper electrode 11). It will be appreciated that the relationship between the potentials to be given to the upper electrode 11 and the lower electrode 12 is not limited to what is exemplified herein. For example, intermediate level displaying may be realized with a fixed potential given to the upper electrode 11 and a variable potential given to the lower electrode 12.

In the liquid crystal display device 100, when conducting displaying such that information which is displayed by the liquid crystal display panel 1 is overlaid on the background, the pixels in the portion of the displaying region where information is to be displayed present either the black displaying state, the white displaying state, or an intermediate level displaying state, whereas the pixels in any other portion present the transparent displaying state. These displaying states can be switched in the following manner, for example.

A driving circuit for a generic liquid crystal display device includes an 8-bit driver IC, and generates output voltages corresponding to 256 gray scale levels (0^{th} to 255^{th} gray scale levels). In a generic liquid crystal display device, the 0^{th} gray scale level is assigned to the black displaying state; the 1^{st} to 254^{th} gray scale levels are assigned to intermediate level displaying states; and the 255^{th} gray scale level is assigned to the white displaying state.

In the liquid crystal display device 100 of the present embodiment, for example, the 0^{th} gray scale level may be assigned to the transparent displaying state, the 1^{st} gray scale level may be assigned to the black displaying state, the 2^{nd} to 254^{th} gray scale levels may be assigned to intermediate level displaying states, and the 255^{th} gray scale level assigned to the white displaying state, thereby being able to switch between the black displaying state, intermediate level displaying states, the white displaying state, and the transparent displaying state. Note that it is not necessary for the transparent displaying state to be associated with the 0^{th} gray scale level, and any gray scale level may be assigned to the transparent displaying state. In cases other than displaying in 256 gray scale levels exemplified herein, too, a specific gray scale level may be assigned to the transparent displaying state.

As described above, in the liquid crystal display device 100 of the present embodiment, each pixel is capable of switchably presenting the black displaying state, the white displaying state, or the transparent displaying state. In any conventional see-through display, regardless of its type (liquid crystal display device, PDLC display, organic EL display, etc.), see-through displaying will need to be performed in either the black displaying state or the white displaying state (i.e., the gray scale level for either the black displaying state or the white displaying state being assigned to see-through displaying), and thus see-through displaying cannot be performed with an applied voltage that differs from those of the black displaying state and the white displaying state. On the other hand, in the liquid crystal display device 100 of the present embodiment, each pixel is able to present not only the black displaying state and the white displaying state, but also the transparent displaying state, with an applied voltage which differs from those of the black displaying state and the white displaying state, whereby doubling blur is prevented.

### Embodiment 2

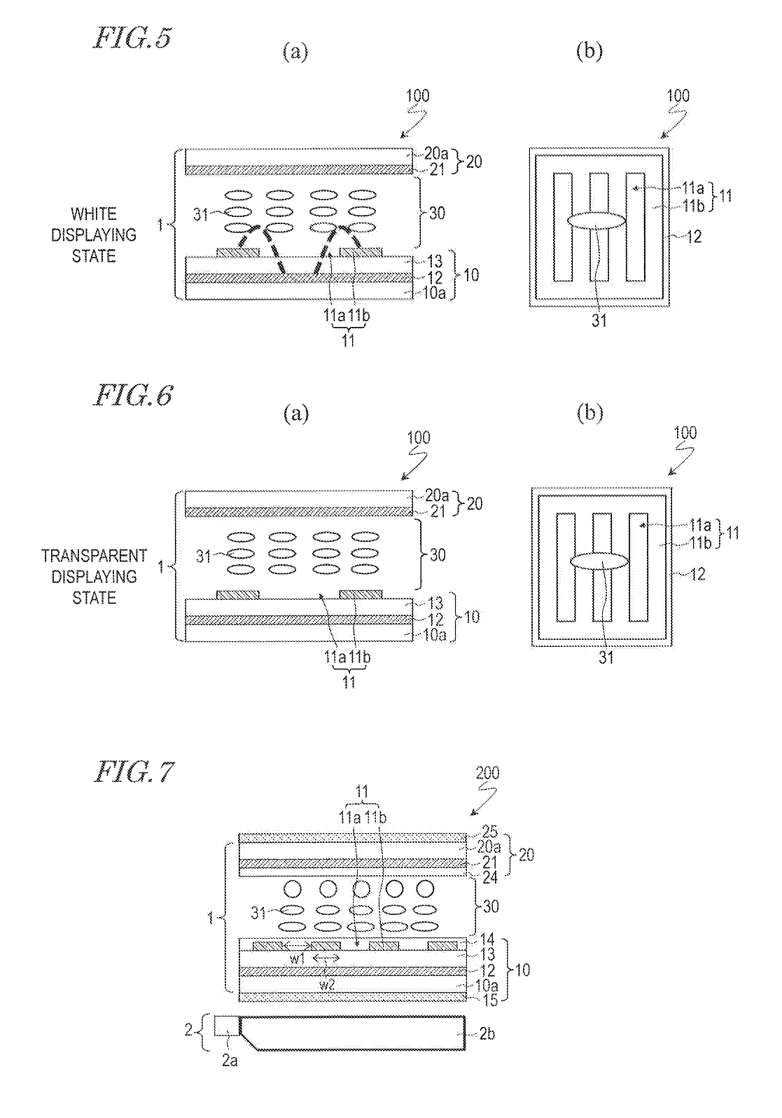

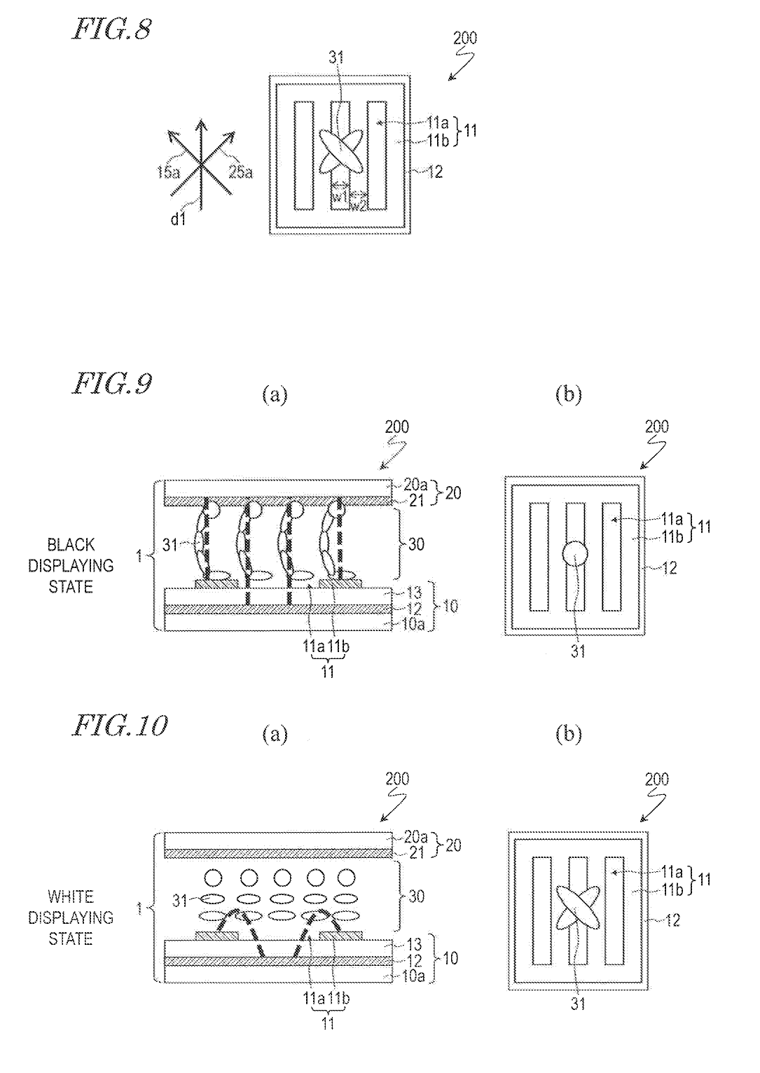

FIG. 7 and FIG. 8 show a liquid crystal display device 200 according to the present embodiment. FIG. 7 is a cross-sectional view schematically showing the liquid crystal display device 200, and FIG. 8 is a plan view schematically showing the liquid crystal display device 200.

The liquid crystal display device 200 differs from the liquid crystal display device 100 of Embodiment 1 in that the liquid crystal molecules 31 take a twist alignment in a state where no voltage is applied to the liquid crystal layer 30 (i.e., a state where no electric field is generated).

Pretilt directions which are respectively defined by the first horizontal alignment film 14 and the second horizontal alignment film 24 of the liquid crystal display device 200 constitute angles of substantially 45° with respect to the direction d1 that the slits 11a in the upper electrode 11 extend. Moreover, the pretilt direction defined by second horizontal alignment film 24 constitutes an angle of 90° with respect to the pretilt direction defined by the first horizontal alignment film 14. Therefore, in a state where no voltage is applied to the liquid crystal layer 30, the liquid crystal molecules 31 take a 90° twist alignment.

Moreover, the first polarizing plate 15 and the second polarizing plate 25 are placed in crossed Nicols, such that the respective transmission axes 15a and 25a of the first polarizing plate 15 and the second polarizing plate 25 are substantially parallel or substantially orthogonal to the pretilt directions respectively defined by the first horizontal alignment film 14 and the second horizontal alignment film 24. Therefore, the respective transmission axes 15a and 25a of the first polarizing plate 15 and the second polarizing plate 25 constitute angles of substantially 45° with respect to the direction d1 that the slits 11a in the upper electrode 11 extend.

In the liquid crystal display device 200 of the present embodiment, too, each of the plurality of pixels is able to switchably present the black displaying state, the white displaying state, or the transparent displaying state. Hereinafter, with reference to FIG. 9, FIG. 10, and FIG. 11, the black displaying state, the white displaying state, and the transparent displaying state will be described in more detail.

FIGS. 9(a) and (b) show an alignment of liquid crystal molecules 31 in the black displaying state. In the black displaying state, a predetermined voltage is applied between the counter electrode 21, the upper electrode 11, and the lower electrode 12 (e.g., a potential of 0 V being given to the counter electrode 21, and a potential of 7.5 V being given to the upper electrode 11 and the lower electrode 12), thereby generating a vertical field across the liquid crystal layer 30. FIG. 9(a) schematically shows the electric lines of force in this state with broken lines.

In this black displaying state, as shown in FIGS. 9(a) and (b), the liquid crystal molecules 31 in the liquid crystal layer 30 are aligned substantially vertically to the substrate plane (the surfaces of the rear substrate 10 and the front substrate 20)(that is, substantially parallel to the layer normal direction of the liquid crystal layer 30).

Note that the liquid crystal molecules 31 in the close neighborhood of the first horizontal alignment film 14 and the second horizontal alignment film 24 are strongly affected by the alignment regulating forces of the first horizontal alignment film 14 and the second horizontal alignment film 24, and therefore remain aligned substantially parallel to the substrate plane. However, since these liquid crystal molecules 31 are substantially parallel or substantially orthogonal to the transmission axis 15a of the first polarizing plate 15, they hardly confer any phase difference to the light passing through the first polarizing plate 15 and entering the liquid crystal layer 30, and thus hardly lower the contrast ratio.

FIGS. 10(a) and (b) show an alignment of liquid crystal molecules 31 in the white displaying state. In the white displaying state, a predetermined voltage is applied between the upper electrode 11 and the lower electrode 12 (e.g., a potential of 0 V being given to the upper electrode 11 and the counter electrode 21, and a potential of 7.5 V being given to the lower electrode 12), thereby generating a lateral field (fringing field) across the liquid crystal layer 30. FIG. 10(a) schematically shows the electric lines of force in this state with broken lines.

In this white displaying state, as shown in FIGS. 10(a) and (b), the liquid crystal molecules 31 in the liquid crystal layer 30 are aligned substantially in parallel to the substrate plane (i.e., substantially vertically to the layer normal direction of the liquid crystal layer 30). More specifically, the liquid crystal molecules 31 in the neighborhood of first horizontal alignment film 14 and the liquid crystal molecules 31 in the neighborhood of second horizontal alignment film 24 are aligned so as to constitute an angle of substantially 90°, whereby the liquid crystal molecules 31 near the center along the thickness direction of the liquid crystal layer 30 are aligned substantially parallel to the direction d1 that the slits 11a in the upper electrode 11 extend. Therefore, an average orientation direction of the bulk liquid crystal is substantially parallel to the direction d1 that the slits 11a extend (i.e., constituting an angle of substantially 45° with respect to the respective transmission axes 15a and 25a of the first polarizing plate 15 and the second polarizing plate 25).

FIGS. 11(a) and (b) show an alignment of liquid crystal molecules 31 in the transparent displaying state. In the transparent displaying state, no voltage is applied to the liquid crystal layer 30 (e.g., a potential of 0 V is given to all of the upper electrode 11, the lower electrode 12, and the counter electrode 21), so that neither a vertical field nor a lateral field is generated across the liquid crystal layer 30.

In this transparent displaying state, the liquid crystal molecules 31 in the liquid crystal layer 30 take a twist alignment, as shown in FIGS. 11(a) and (b). In other words, the liquid crystal molecules 31 are aligned substantially in parallel to the substrate plane (i.e., substantially vertically to the layer normal direction of the liquid crystal layer 30). The liquid crystal molecules 31 in the neighborhood of first horizontal alignment film 14 and the liquid crystal molecules 31 in the neighborhood of second horizontal alignment film 24 are aligned so as to constitute an angle of substantially 90°, whereby the liquid crystal molecules 31 near the center along the thickness direction of the liquid crystal layer 30 are aligned substantially parallel to the direction d1 that the slits 11a in the upper electrode 11 extend. Therefore, an average orientation direction of the liquid crystal molecules 31 in the bulk liquid crystal are substantially parallel to the direction d1 that the slits 11a extend (i.e., constituting an angle of substantially 45° with respect to the respective transmission axes 15a and 25a of the first polarizing plate 15 and the second polarizing plate 25). The light transmittance of each pixel of the liquid crystal display device 200 is the highest in this transparent displaying state (i.e., higher than those in the black displaying state and the white displaying state).

As described above, in the liquid crystal display device 200 of the present embodiment, a vertical field is generated across the liquid crystal layer 30 in the black displaying state and a lateral field is generated across the liquid crystal layer 30 in the white displaying state; therefore, torque due to voltage application can act on the liquid crystal molecules 31 in both a fall (i.e., a transition from the white displaying state to the black displaying state) and a rise (i.e., a transition from the black displaying state to the white displaying state). As a result, good response characteristics are attained.

Moreover, in the liquid crystal display device 200 of the present embodiment, each pixel is capable of presenting not only the black displaying state and the white displaying state, but also the transparent displaying state, which is a state where no voltage is applied to the liquid crystal layer 30. By displaying the background in this transparent displaying state, it becomes possible to prevent doubling blur, thereby improving the quality of see-through displaying similarly to the liquid crystal display device 100 of Embodiment 1.

Note that, if the white displaying state of the liquid crystal display device 200 is used for see-through displaying, doubling blur will similarly occur. The reason is that, in the white displaying state, a refractive index distribution occurs within the pixel under the influence of the electric field being generated in the liquid crystal layer 30. While FIG. 10(a) shows an ideal alignment, in actuality, the liquid crystal molecules 31 in the white displaying state will not take a uniform twist alignment, unlike in the transparent displaying state (see FIG. 13 described later); therefore, a lower transmittance than that in the transparent displaying state will result.

As described above, the liquid crystal display device 100 of the present embodiment excels in both response characteristics and display quality, and thus is suitably used as a see-through display.

Now, a simulated estimation of the effect of response speed improvement resulting from voltage application during white displaying will be discussed. As simulation software, LCD MASTER 2D (manufactured by SHINTECH, Inc.) was used for the simulation. The cell thickness (i.e., thickness of the liquid crystal layer 30) was 3.5 μm, and the insulating layer 13 had a resin layer with a thickness of 1 μm and a dielectric constant ∈ of 3.4 and a passivation layer with a thickness of 0.3 μm and a dielectric constant ∈ of 6.9, these being stacked. The branches 11b of the upper electrode 11 had a width w2 of 3 μm and the slits 11a had a width w1 of 4 μm (i.e., L/S=3 μm/4 μm). Furthermore, the pretilt directions respectively defined by the first horizontal alignment film 14 and the second horizontal alignment film 24 constituted angles of 45° with respect to the direction d1 that the slits 11a in the upper electrode 11 extended.

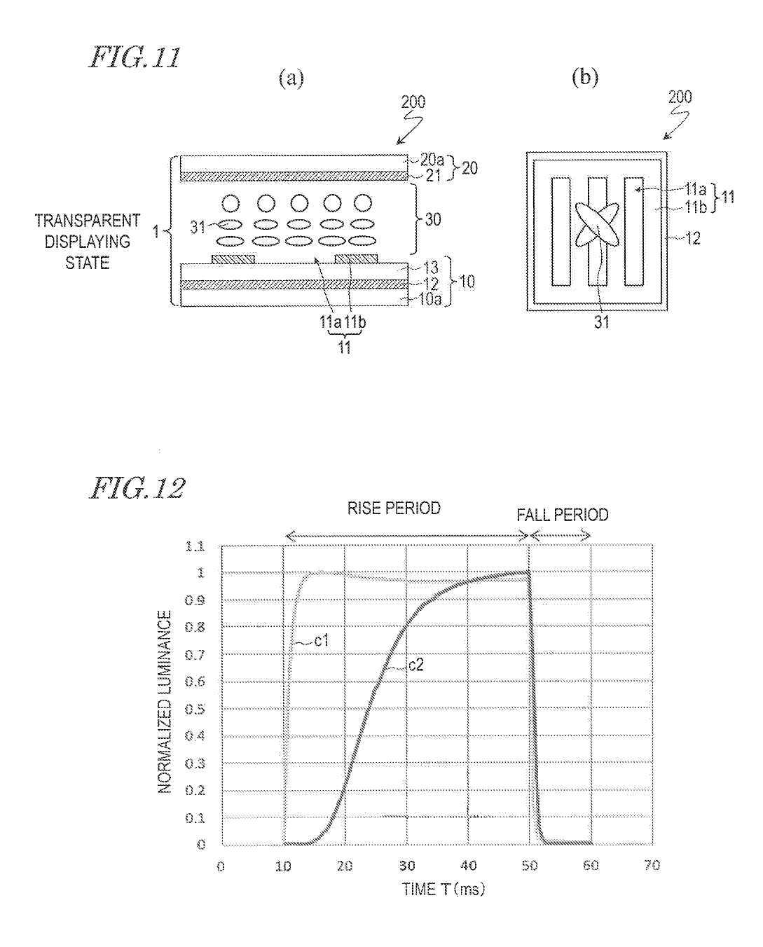

FIG. 12 and FIG. 13 show results of the simulation. FIG. 12 shows a relationship (curve c1) between time T (ms) and normalized luminance in a rise period (a transitional period from the black displaying state to the white displaying state: T=10 to 50 ms) and a fall period (a transitional period from the white displaying state to the black displaying state: T=50 ms to 60 ms). For comparison's sake, FIG. 12 also shows a relationship (curve c2) between time T(ms) and normalized luminance in a transitional period (T=10 to 50 ms) from the black displaying state to the absence of an applied voltage (transparent displaying state) and a transitional period (T=50 ms to 60 ms) from the absence of an applied voltage (transparent displaying state) to the black displaying state. FIG. 13 shows equipotential lines and orientation directions of the liquid crystal molecules 31 at 39 ms after start of a rise period (T=49 ms).

As can be seen from FIG. 12, in a transition from the black displaying state to the white displaying state (i.e., a lateral field being generated across the liquid crystal layer 30), the increase in normalized luminance is more rapid than in a transition from the black displaying state to the absence of an applied voltage (i.e., no electric field being generated across the liquid crystal layer 30), indicative of an improved response speed. Specifically, the response time in the former case (i.e., the time needed for the normalized luminance to change from 0.1 to 0.9, called the rise response time τr) is 2.2 ms, whereas the response time in the latter case (the time needed for the normalized luminance to change from 0.1 to 0.9) is 16.2 ms. The response time in a transition from the white displaying state to the black displaying state (the time needed for the normalized luminance to change from 0.9 to 0.1, called the fall response time τd) and the response time (the time needed for the normalized luminance to change from 0.9 to 0.1) in a transition from the transparent displaying state to the black displaying state are both about 2.0 ms, i.e., essentially the same.

Moreover, from a comparison between the normalized luminance in the white displaying state and the normalized luminance in the transparent displaying state (comparison at the point T=50 ms), it can be seen that the light transmittance is higher in the transparent displaying state than in the white displaying state. When conducting multicolor displaying by the field sequential method, good response characteristics are expected of the white displaying state, even somewhat at the cost of light transmittance. On the other hand, the transparent displaying state is expected to provide a high light transmittance, rather than good response characteristics. This means that realizing the white displaying state by voltage application and realizing the transparent displaying state by absence of an applied voltage, as in the liquid crystal display device 200 of the present embodiment (or the liquid crystal display device 100 of Embodiment 1), is very suitable for a see-through display under the field sequential method.

Note that the present embodiment illustrates an exemplary construction where, in the white displaying state, the liquid crystal molecules 31 near the center along the thickness direction of the liquid crystal layer 30 are aligned substantially parallel to the direction d1 that the slits 11a in the upper electrode 11 extend (i.e., an average orientation direction of the bulk liquid crystal is substantially parallel to the direction d1 that the slits 11a extend) (hereinafter referred to as “Construction 1”). On the other hand, another construction may also be adopted where, in the white displaying state, the liquid crystal molecules 31 near the center along the thickness direction of the liquid crystal layer 30 are aligned so as to be substantially orthogonal to the direction d1 that the slits 11a in the upper electrode 11 extend (i.e., an average orientation direction of the bulk liquid crystal is substantially orthogonal to the direction d1 that the slits 11a extend) (hereinafter referred to as “Construction 2”). However, the inventors have conducted a simulation study to find that, from the standpoint of attaining further improvements in response characteristics, it is more preferable to adopt Construction 1 (of course, Construction 2 may instead be adopted).

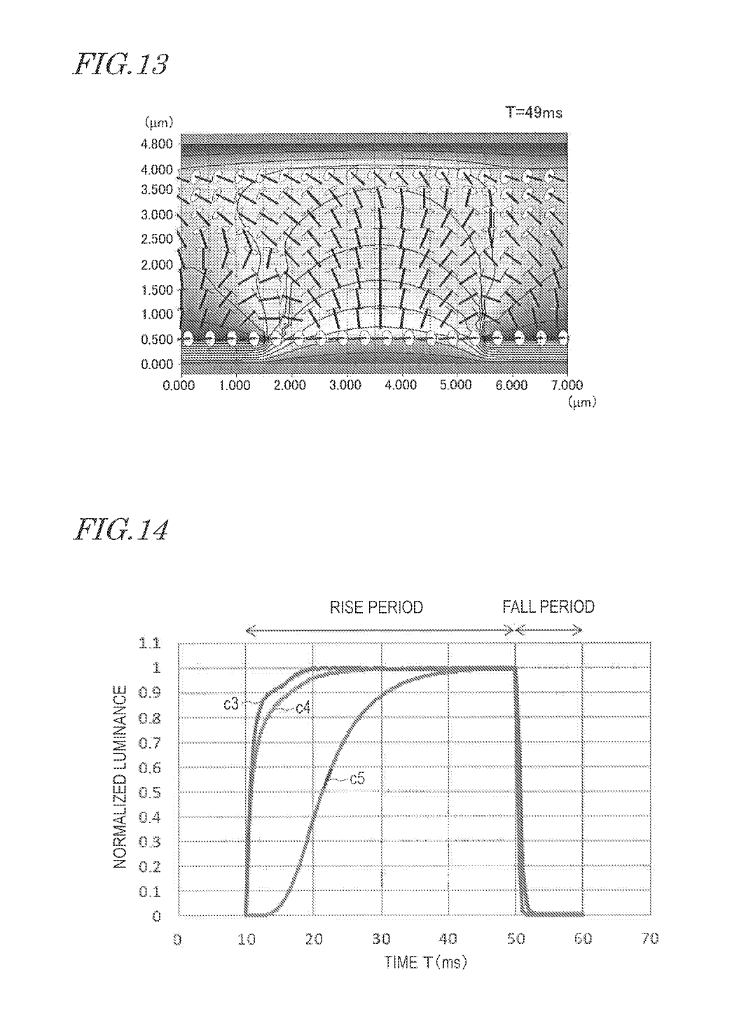

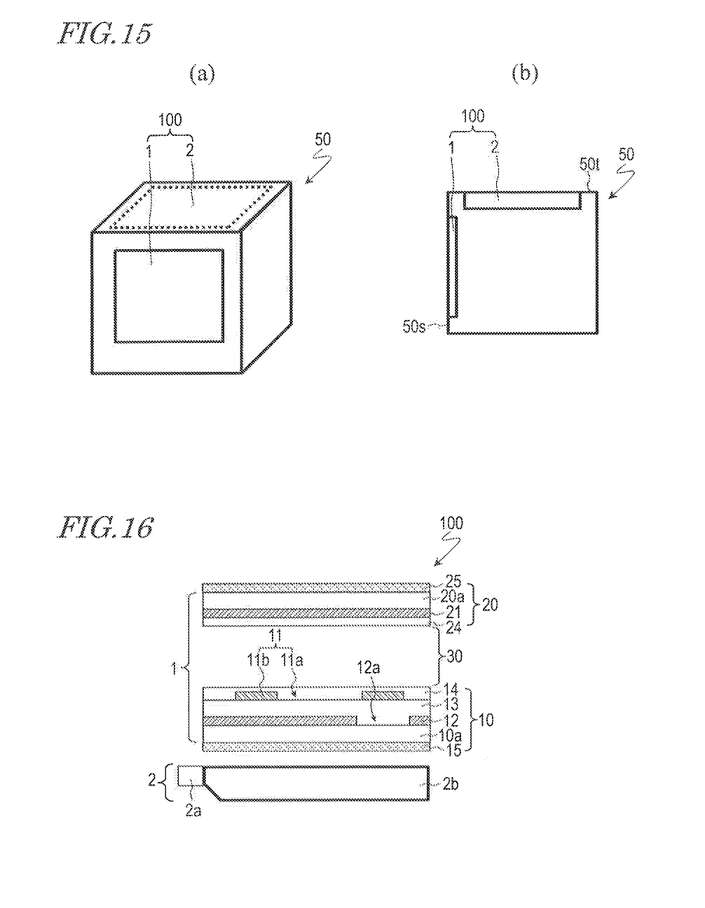

FIG. 14 shows a relationship between time T(ms) and normalized luminance in a rise period (T=10 to 50 ms) and a fall period (T=50 ms to 60 ms), with respect to both Construction 1 (curve c3) and Construction 2 (curve c4). For reference's sake, FIG. 13 also shows a relationship (curve c5) between time T(ms) and normalized luminance in a transitional period (T=10 to 50 ms) from the black displaying state to the absence of an applied voltage (transparent displaying state) and a transitional period (T=50 ms to 60 ms) from the absence of an applied voltage (transparent displaying state) to the black displaying state.

As can be seen from FIG. 14, when Construction 1 is adopted, the increase in normalized luminance is more rapid than when Construction 2 is adopted, indicative of a further improved response speed. Thus, from the standpoint of response characteristics, it is preferable to adopt Construction 1.

As described above, according to embodiments of the present invention, the response characteristics and display quality of a liquid crystal display device for use as a see-through display can be improved. Note that, the specific construction of a liquid crystal display device according to an embodiment of the present invention is not limited to what is exemplified in Embodiments 1 and 2 above.

Although FIG. 1 and FIG. 6 illustrate a construction in which an edgelight-type backlight is disposed as the illumination element 2 on the rear face side of the liquid crystal display panel 1 so as to overlap the liquid crystal display panel 1, the illumination element 2 is not to be limited to this example.

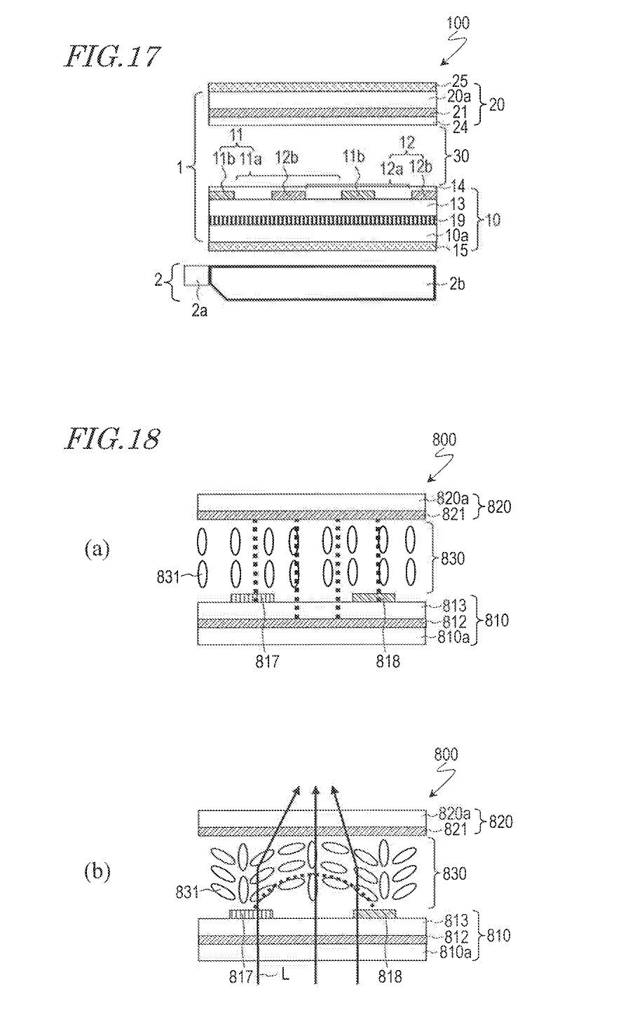

For example, a construction shown in FIG. 15 may be adopted. In the construction shown in FIG. 15, the liquid crystal display panel 1 and the illumination element 2 of the liquid crystal display device 100 are attached on a transparent case 50 of a box shape. The case 50 having the liquid crystal display panel 1 and the illumination element 2 attached thereto is used as a showcase, for example.

The liquid crystal display panel 1 is attached to a side face 50s, among a plurality of side faces of the case 50. The illumination element 2 is attached to an upper face 50t of the case 50. In a manner described above, the illumination element 2 is capable of switchably irradiating the liquid crystal display panel 1 with a plurality of color rays including red light, green light, and blue light. From the standpoint of enhancing the efficiency of light utilization (i.e., allowing as much light from the illumination element 2 to enter the liquid crystal display panel 1 as possible), it is preferable that the inner surface of the case 50 has a light diffusing property.

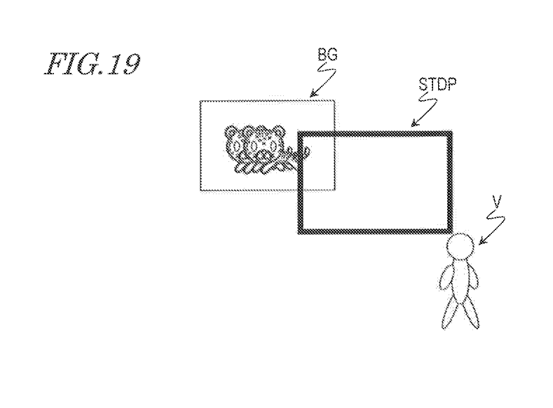

Moreover, the electrode structure is not limited to what is exemplified in FIG. 1 and the like, either. For example, electrode structures shown in FIG. 16 and FIG. 17 may be adopted. The example shown in FIG. 16 differs from the example shown in FIG. 1 in that the lower electrode (second electrode) 12 has slits 12a. An electrode structure in which the lower electrode has slits is disclosed in International Publication No. 2013/001980. Since the lower electrode 12 has the slits 12a, as is described in International Publication No. 2013/001980, further improvements in response characteristics and light transmittance can be made.

In the example shown in FIG. 17, a fourth electrode is provided as the lower electrode. On this fourth electrode (lower electrode) 14, a first electrode 11 and a second electrode 12 are provided as the upper electrode, via an insulating layer 13.

The first electrode 11 is of an interdigitated shape, including a plurality of slits 11a and a plurality of branches 11b. The second electrode 12 is also of an interdigitated shape, including a plurality of slits 12a and a plurality of branches 12b. The branches 11b of the first electrode 11 are located within the slits 12a of the second electrode 12, and branches 12b of the second electrode 12 are located within the slits 11a of the first electrode 11. That is, the interdigitated first electrode 11 and second electrode 12 are disposed so that the respective branches 11b and 12b thereof mesh with each other.

In the example shown in FIG. 17, a lateral field is generated by the first electrode 11 and the second electrode 12, and a vertical field is generated by the first electrode 11, the second electrode 12, the third electrode 13, and the fourth electrode 14. In other words, a lateral field is generated by the pair of interdigitated electrodes being provided as the upper electrode (the first electrode 11 and second electrode 12). A pixel having the electrode structure shown in FIG. 17 is also able to switchably present the black displaying state, the white displaying state, or the transparent displaying state.

Although the above description is directed to the case of conducting multicolor displaying by the field sequential method, a liquid crystal display device according to an embodiment of the present invention does not need to be of the type that performs multicolor displaying by the field sequential method. Even in a type of liquid crystal display device whose liquid crystal display panel includes color filters, the ability of a pixel to switchably present the black displaying state, the white displaying state, or the transparent displaying state will prevent doubling blur.

### INDUSTRIAL APPLICABILITY

According to an embodiment of the present invention, there is provided a liquid crystal display device which excels in both response characteristics and display quality, the liquid crystal display device being suitable for use as a see-through display. A liquid crystal display device (see-through display) according to an embodiment of the present invention is used as a display device for an information display system or digital signage, for example.

### REFERENCE SIGNS LIST

1 liquid crystal display panel
2 illumination element
2a light source unit
2b light guide plate
10 first substrate (rear substrate)
10a transparent substrate
11 first electrode (upper electrode)
11a slit
11b branch
12 second electrode (lower electrode, upper electrode)
12a slit
12b branch
13 insulating layer
14 first horizontal alignment film
15 first polarizing plate
15a transmission axis of first polarizing plate
16A first TFT
16B second TFT
17 gate bus line
18 source bus line
19 fourth electrode (lower electrode)
20 second substrate (front substrate)
20a transparent substrate
21 third electrode (counter electrode)
24 second horizontal alignment film
25 second polarizing plate
25a transmission axis of second polarizing plate
30 liquid crystal layer
31 liquid crystal molecules
50 case
100, 200 liquid crystal display device

1-15. (canceled)

16. A liquid crystal display device comprising a liquid crystal display panel including a first substrate and a second substrate opposing each other and a liquid crystal layer provided between the first substrate and the second substrate,
the liquid crystal display device having a plurality of pixels arranged in a matrix array, wherein,
the first substrate includes a first electrode provided for each of the plurality of pixels, and a second electrode for generating a lateral field across the liquid crystal layer in cooperation with the first electrode;
the second substrate includes a third electrode opposing the first electrode and the second electrode for generating a vertical field across the liquid crystal layer in cooperation with the first electrode and the second electrode;
each of the plurality of pixels is capable of switchably presenting
a black displaying state where black displaying is performed with a vertical field being generated across the liquid crystal layer,
a white displaying state where white displaying is performed with a lateral field being generated across the liquid crystal layer, or
a transparent displaying state where a rear face side of the liquid crystal display panel is visible in a see-through manner with no voltage being applied to the liquid crystal layer;
in the transparent displaying state, liquid crystal molecules in the liquid crystal layer take a twist alignment;
the first electrode has a plurality of slits extending along a predetermined direction; and
in the white displaying state and the transparent displaying state, the liquid crystal molecules near a center along a thickness direction of the liquid crystal layer are aligned substantially parallel or substantially orthogonal to the predetermined direction.

17. The liquid crystal display device of claim 16, wherein,
the liquid crystal display panel further includes a pair of horizontal alignment films opposing each other via the liquid crystal layer; and
a pretilt direction defined by each of the pair of horizontal alignment films constitutes an angle of substantially 45° with respect to the predetermined direction.

18. The liquid crystal display device of claim 17, wherein,
the liquid crystal display panel further includes a pair of polarizing plates opposing each other via the liquid crystal layer, the pair of polarizing plates being placed in crossed Nicols; and
respective transmission axes of the pair of polarizing plates are substantially parallel or substantially orthogonal to the respective pretilt directions defined by the pair of horizontal alignment films.

19. The liquid crystal display device of claim 16, wherein the first electrode is provided via an insulating layer on the second electrode.

20. The liquid crystal display device of claim 16, wherein,
the first substrate further includes a fourth electrode for generating a vertical field across the liquid crystal layer in cooperation with the first electrode, the second electrode, and the third electrode; and
the first electrode and the second electrode are provided via an insulating layer on the fourth electrode.

21. The liquid crystal display device of claim 16, wherein the liquid crystal layer contains liquid crystal molecules having positive dielectric anisotropy.

22. The liquid crystal display device of claim 16, further comprising an illumination element capable of switchably irradiating the liquid crystal display panel with a plurality of color rays including red light, green light, and blue light.

23. The liquid crystal display device of claim 16, performing multicolor displaying by a field sequential method.

24. The liquid crystal display device of claim 16, wherein the liquid crystal display panel includes no color filters.
